(19) United States
(12) Patent Application Publication
(10) Pub. No.: US 2006/0047505 A1
(43) Pub. Date: Mar. 2, 2006

(54) Electronic device

(75) Inventors: Takafumi Kikuchi, Ome-shi (JP); Yoichiro Tanaka, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/215,016

(22) Filed: Aug. 31, 2005

(30) Foreign Application Priority Data
Aug. 31, 2004 (JP) 2004-252437

(51) Int. Cl. G10L 11/00

(52) U.S. Cl. 704/200

(57) ABSTRACT

A disk device and microphone are arranged in a device main body. The case of the disk device includes a first shell having a bottom, and a second shell having a top cover. A disk-shaped recording medium is contained in the case. The microphone is positioned closer to the top cover of the disk device than to the bottom of the disk device in the thickness direction of the device main body. Assuming that θ represents the angle between straight line connecting the disk device to the microphone by the most direct way, and a plane parallel to a surface of the top cover of the disk device, the disk device and microphone arranged to satisfy the following relationship with respect to the maximum deformation angle α of the top cover of the disk device in a lowest-order vibration mode: 0≦θ<90°−α.

### CROSS-REFERENCE TO RELATED APPLICATIONS

This application is based upon and claims the benefit of priority from prior Japanese Patent Application No. 2004-252437, filed Aug. 31, 2004, the entire contents of which are incorporated herein by reference.

### BACKGROUND OF THE INVENTION

1. Field of the Invention

This invention relates to an electronic device with a microphone and to a disk device.

2. Description of the Related Art

In recent years, portable compact electronic devices represented by, for example, mobile phones, digital cameras, video cameras, personal digital assistants (PDAs) are provided with a microphone for voice input. Further, some of the electronic devices use a disk device, such as a magnetic disk device or optical disk device, as a storage device.

A magnetic disk device as an example of the disk device generally has a rectangular case. The case contains magnetic disks as a magnetic recording medium, a spindle motor, magnetic heads, and a head actuator. The spindle motor serves as drive means that supports and rotates the disks. The magnetic heads are used to write and read information to and from the disks. The head actuator supports the heads for movement with respect to the disks. The case further contains a voice coil motor and a substrate unit, etc. The voice coil motor rotates and positions the head actuator. The substrate unit has a head IC and the like.

As disclosed in, for example, Jpn. Pat. Appln. KOKAI Publication No. 2001-210058, such a magnetic disk device as installed in a portable electronic device is significantly reduced in size compared to conventional magnetic devices, and is formed thin in the shape of a card.

Since in such a compact electronic device as the above, the space for installing each component is small, the disk device and microphone may be located adjacent to each other. In this case, the microphone may well be adversely influenced by the vibration of the disk device. More specifically, during the operation of the magnetic disk, vibration due to the rotation of the spindle motor or the seeking operation of the carriage occurs. Since the base and top cover, which provide the case, have come to be formed thinner in accordance with a reduction in the size and thickness of the magnetic device, vibration will easily occur. Part of the vibration wave vibrates the air using, as emission surfaces, the base surface and top cover surface of the magnetic disk device, and reaches the microphone. The vibration component reaching the microphone appears as noise and makes it difficult to acquire clear voice data through the microphone.

### BRIEF SUMMARY OF THE INVENTION

According to an aspect of the invention, there is provides an electronic device comprising: a disk device arranged in the device main body, the disk device including a rectangular case provided with a bottom and a top cover opposing the bottom, and a disk-shaped recording medium contained in the case; and a microphone arranged in the device main body closer to the top cover of the disk device than to the bottom of the disk device in a thickness direction of the device main body. The disk device and microphone are arranged to satisfy the following relationship with respect to a maximum deformation angle α of the top cover of the disk device in a lowest-order vibration mode:
0≦θ<90°−α
where θ represents an angle between a straight line connecting the disk device to the microphone by a most direct way, and a plane parallel to a surface of the top cover of the disk device.

According to another aspect of the invention, there is provides an electronic device comprising: a disk device; a disk device arranged in the device main body, the disk device including a rectangular case provided with a bottom and a top cover opposing the bottom, and a disk-shaped recording medium contained in the case; and a microphone arranged in the device main body closer to the bottom of the disk device than to the top cover of the disk device in a thickness direction of the device main body. The disk device and microphone are arranged to satisfy the following relationship with respect to a maximum deformation angle α of the bottom of the disk device in a lowest-order vibration mode:
0≦β<90°−α
where β represents an angle between a straight line connecting the disk device to the microphone by a most direct way, and a plane parallel to a surface of the bottom of the disk device.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a mobile phone according to a first embodiment of the invention;

FIG. 2 is a perspective view showing a hard disk drive (hereinafter referred to as an HDD) installed in the mobile phone;

FIG. 3 is an exploded perspective view of the HDD;

FIG. 4 is a sectional view showing the main unit, HDD and microphone of the mobile phone;

FIG. 5 is a perspective view schematically showing a lowest-order vibration mode employed in the HDD;

FIG. 6 is a view showing the deflection curve of the top cover of the mobile phone assumed when the HDD vibrates;

FIG. 7 is a sectional view showing the main unit of a mobile phone according to a second embodiment of the invention;

FIG. 8 is a sectional view showing the main unit of a mobile phone according to a third embodiment of the invention;

FIG. 9 is a partly-sectional side view showing a mobile phone according to a fourth embodiment of the invention; and

FIG. 10 is a sectional view showing the main unit of a mobile phone according to a fifth embodiment of the invention.

### DETAILED DESCRIPTION OF THE INVENTION

A first embodiment, in which the invention is applied to a mobile phone as an example of an electronic device, will be described in detail with reference to the accompanying drawings.

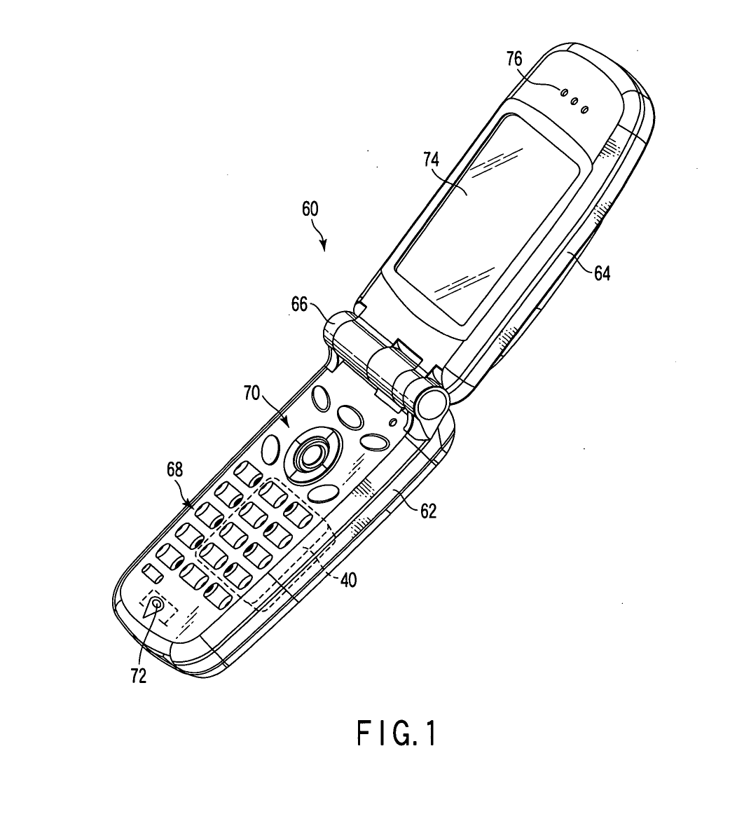

As shown in FIG. 1, a mobile phone 60 comprises a device main body that includes first and second main units 62 and 64 formed flat and rectangular. The second main unit 64 is rotatably coupled to the first main unit 62 by a hinge 66. A ten-key pad 68 and a plurality of operation keys 70 are provided on the first main unit 62. The first main unit 62 contains an HDD 40 functioning as a storage device, and a microphone 72, etc. The second main unit 64 contains a display panel 74 for displaying transmission data, received data, etc., and a speaker 76, etc.

The HDD 40 as a disk device will now be described in detail.

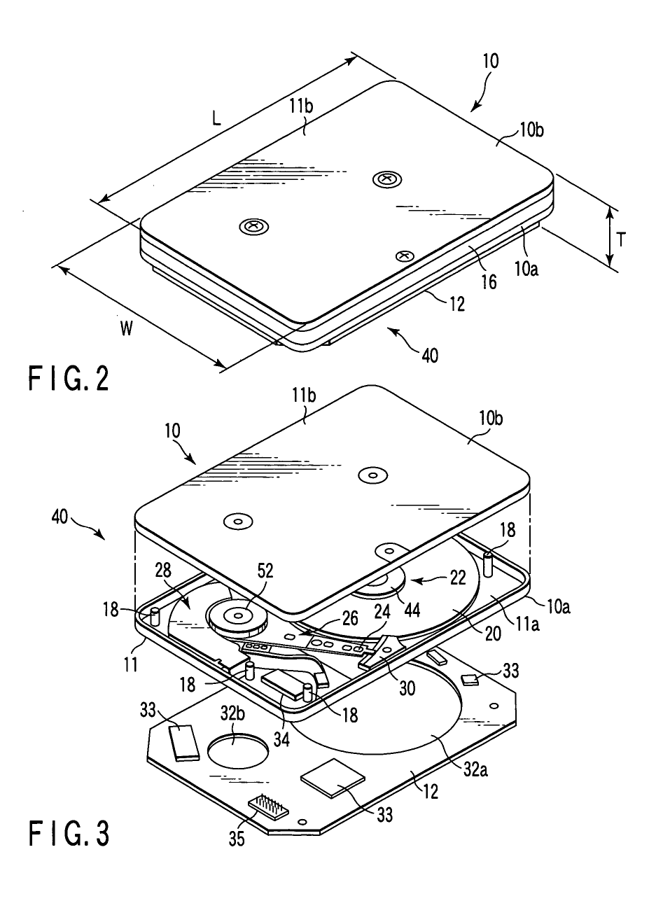

As shown in FIGS. 2 and 3, the HDD 40 comprises a case 10 in the form of a substantially rectangular box and a rectangular control circuit board 12 stacked on the outer surface of the case 10. The case 10 contains various members, which will be described later. The case 10 and the circuit board 12 each have a length L not longer than 4 cm, for example, 32 mm, and a width W of 24 mm. The thickness T of a structure that includes the case 10 and the control circuit board 12 is set to, e.g., about 3.3 mm or 5 mm, depending on the number of disks to be held in the case.

The case 10 comprises a first shell 10a and a second shell 10b that have substantially equal dimensions. The first and second shells 10a and 10b are substantially rectangular metallic structures, which have sidewalls set up on their respective peripheral edge portions.

The shells 10a and 10b are arranged facing each other with their peripheral edge portions opposed. A belt-shaped seal member 16 rounds around the peripheral edge portions of the shells 10a and 10b. The seal member 16 connects the peripheral edge portions of the shells 10a and 10b and seals a gap between them. Thus, the case 10 is formed in the shape of a rectangular box.

The bottom surface of the first shell 10a forms a rectangular mounting surface 11. Four corners of the case 10, including the corners of the mounting surface 11, are rounded in a circular arc. Thus, the seal member 16 that rounds around the peripheral edge portion of the case 10 is prevented from being damaged by the corners of the case, and airtightness is prevented from being lowered by lifting of the seal member.

As shown in FIGS. 2 and 3, in the case 10, a plurality of support posts 18 are provided on the peripheral edge portion of the case. Each support post 18 has a proximal end fixed to the inner surface of the first shell 10a and is set substantially upright on the inner surface of the first shell. Corresponding to each support post 18 in position, a tapped hole is formed in the mounting surface 11 and extends into the post.

The case 10 contains a magnetic disk 20 of, e.g., 0.85-inch diameter, for use as an information recording medium, a spindle motor 22, a magnetic head 24, and a carriage 26. The spindle motor 22 supports and rotates the disk 20. The magnetic head 24 is used to write and read information to and from the disk 20. The carriage 26 supports the magnetic head 24 for movement with respect to the magnetic disk 20. Further, the case 10 contains a voice coil motor (hereinafter referred to as a VCM) 28, a ramp load mechanism 30, a solenoid latch 32, a substrate unit 34, etc. The VCM 28 rotates and positions the carriage 26. The ramp load mechanism 30 unloads into and holds the magnetic head 24 in a position off the magnetic disk 20 when the head is moved to the peripheral edge portion of the disk. The solenoid latch 32 holds the carriage 26 in a shunt position. The substrate unit 34 has a head IC and the like.

The spindle motor 22 has a columnar hub with the magnetic disk 20 coaxially fitted thereon. An annular clamp ring 44 is fitted on an end portion of the hub and holds the inner peripheral edge portion of the disk 20. Thus, the disk 20 is fixed to the rotor and supported so that it can rotate together with the rotor.

The carriage 26 that constitutes part of the head actuator is provided with a bearing assembly 52 fixed on the inner surface of the first shell 10a, an arm extending from the bearing assembly, a suspension of an elongate plate shape extending from the distal end of the arm, and a support frame extending from the bearing assembly in a direction opposite to the arm. The magnetic head 24 is supported on an extended end of the suspension by a gimbals portion (not shown). The head 24 is subjected to a given head load toward the surface of the magnetic disk 20 by the spring force of the suspension. A voice coil that constitutes the VCM 28 is fixed integrally to the support frame.

The control circuit board 12, a printed circuit board, is a rectangular structure that is substantially equal to the mounting surface 11 of the case 10 in length and width. The mounting surface 11 of the case 10 is formed having circular bosses that correspond to the spindle motor 22 and the bearing assembly 52, respectively. The control circuit board 12 is formed having circular openings 32a and 32b that correspond to the respective bosses. The four corner portions of the circuit board 12 are obliquely cut at 45 degrees to each side. A plurality of electronic components 33, a connector 35 and the like are mounted on the circuit board 12.

The control circuit board 12, constructed in this manner, is stacked upon the mounting surface 11 of the case 10 and screwed to the first shell 10a with screws. As this is done, the circuit board 12 is located with its four sides aligned or coincident individually with four sides of the mounting surface 11. The respective bosses on the mounting surface 11 are located in the openings 32a and 23b of the circuit board 12. The connector 35 on the circuit board 12 is connected to the connector on the substrate unit 34.

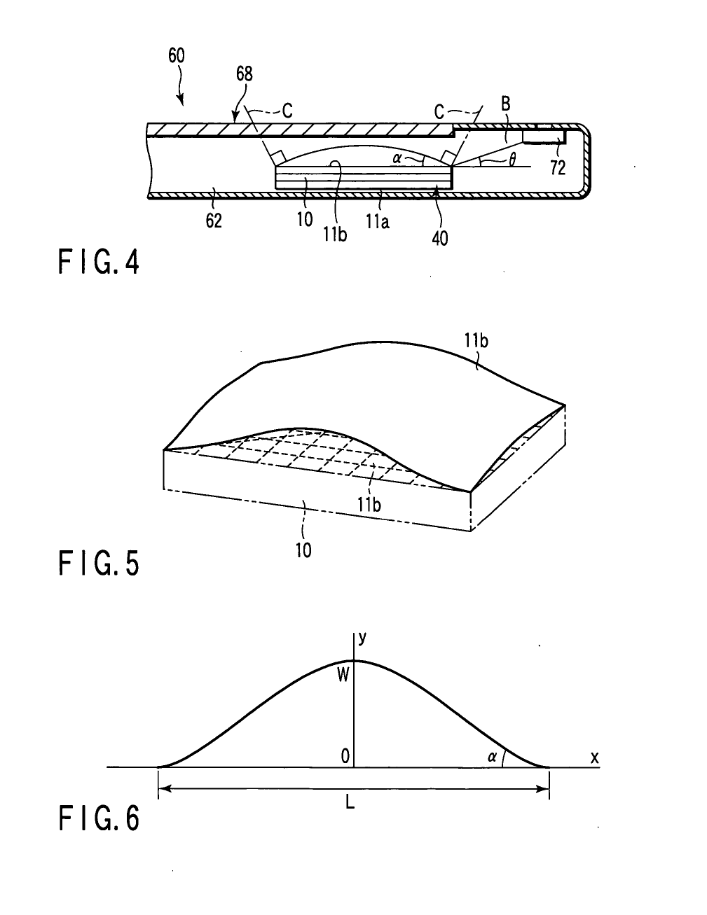

The HDD 40 constructed as described above is contained in the first main unit 62 of the mobile phone 60 as shown in FIGS. 1 and 4. The HDD 40 is located under, for example, the ten-key pad 68 with the bottom 11a kept substantially parallel to the wall of the first main unit 62. The microphone 72 is contained in the first main unit 62 and fixed to the inner surface thereof. Thus, the microphone 72 is located closer to the top cover 11b of the HDD 40 than to the bottom 11a of the HDD in the thickness direction of the first main unit 62.

As can be seen from FIG. 4, the HDD 40 and microphone 72 are arranged to satisfy the following relationship. Assuming that θ represents the angle between straight line B connecting the HDD 40 to the microphone 72 by the most direct way, and a plane parallel to the surface of the top cover 11b of the HDD, the HDD 40 and microphone 72 are arranged to satisfy the following relationship with respect to the maximum deformation angle αmax of the top cover 11b in the lowest-order vibration mode:
0≦θ<90°−α max

Where the HDD 40 and microphone 72 are arranged to satisfy the above relationship, noise due to the vibration of the HDD 40 can be prevented from being transmitted to the microphone 72, thereby enabling clear voice data to be acquired through the microphone 72.

More specifically, during the operation of the HDD 40, vibration occurs because of the rotation of the spindle motor and the seeking operation of the carriage. Part of the vibration wave vibrates the air using, as emission surfaces, the bottom 11a and the top cover 11b of the HDD 40. Since in the embodiment, the microphone 72 is provided closer to the top cover 11b of the HDD 40 than to the bottom 11a, the vibration of the top cover 11b will mainly be described.

The lowest-order vibration mode of the top cover 11b of the HDD 40 differs depending upon the method of attachment. When the HDD is fixed at four points as shown in FIGS. 4 and 5, which is regarded as the worst condition, it will assume a deformed state in which the amplitude w of the center of the top cover 11b is maximum, namely, it will be most easily excited. The intensity (energy) of noise emitted from the surface of the top cover 11b is proportional to the square of the vibration frequency in the normal direction C of the top cover surface. In light of this, the microphone 72 is located at a position slightly deviated from the normal direction C of the surface of the top cover 11b in the lowest-order vibration mode, with the result that the influence of the propagation of vibration through the air is suppressed.

A description will now be given of how to estimate the maximum deformation angle of the top cover surface in the lowest-order vibration mode. As shown in FIG. 6, assuming that the X-axis indicates the length of the HDD 40, the length of the top cover 11b is L, and the maximum amplitude of the center of the top cover is w, the deflection curve of the top cover 11b along the X-axis can be defined as a fourth-order even function. In this case, it is assumed that the longitudinal opposite ends of the top cover 11b are fixed, and the inclination at the opposite ends is zero. The maximum deformation angle αmax of the deflection curve is given by

$${α}_{max} = {tan}^{- 1} ( \frac{16 \sqrt{3}}{9} \frac{w}{L} )$$

If the maximum amplitude w is a tenth part of the length L of the top cover 11b, the maximum deformation angle αmax is about 0.3 (rad).

When the HDD 40 and microphone 72 are located to set, such that θ<π/2−αmax, the angle α between straight line B connecting the HDD to the microphone by the most direct way, and a plane parallel to the surface of the top cover 11b, the microphone is deviated from the normal direction C of the top cover surface in the lowest-order vibration mode. In this state, noise transmitted to the microphone 72 can be reduced.

In the mobile phone 60 constructed as described above, the influence of noise due to the HDD 40 upon the microphone 72 can be reduced and clear voice data can be acquired through the microphone by offsetting the microphone from the vibration transmission (noise emission) direction of the HDD 40.

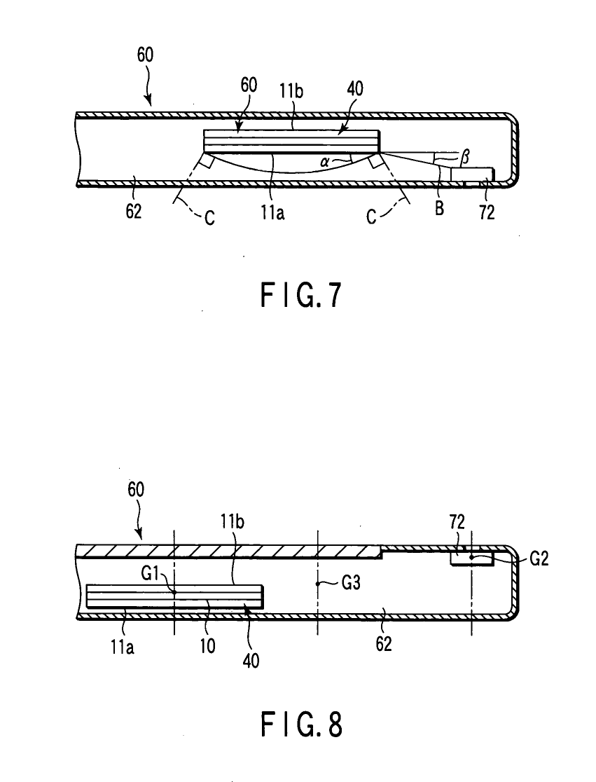

In the above-described embodiment, the microphone 72 is located closer to the top cover 11b of the HDD 40 than to the bottom 11a of the HDD in the thickness direction of the first main unit 62. However, the microphone 72 may be located closer to the bottom 11a of the HDD 40 than to the top cover 11b as in the second embodiment shown in FIG. 7. In this case, the HDD 40 and microphone 72 are located to satisfy the following relationship.

Assuming that β represents the angle between straight line B connecting the HDD 40 to the micro-phone 72 by the most direct way, and a plane parallel to the surface of the bottom 11a of the HDD, the HDD 40 and microphone 72 are arranged to satisfy the following relationship with respect to the maximum deformation angle αmax of the bottom 11a in the lowest-order vibration mode:
0≦β<90°−α max

When the HDD 40 and microphone 72 are arranged to satisfy the above relationship, noise due to the vibration of the HDD 40 can be prevented from being transmitted to the microphone 72, thereby enabling clear voice data to be acquired through the microphone.

FIG. 8 shows a mobile phone according to a third embodiment of the invention. In the third embodiment, the HDD 40 and microphone 72 are arranged in the first main unit 62. The microphone 72 is located closer to the top cover 11b of the HDD 40 in the thickness direction of the first main unit 62. As in the first embodiment, the HDD 40 and microphone 72 are arranged to satisfy the following relationship:
0≦θ<90°−α max

Where the HDD 40 and microphone 72 are arranged to satisfy the above relationship, noise due to the vibration of the HDD 40 can be prevented from being transmitted to the microphone 72, thereby enabling clear voice data to be acquired through the microphone.

In general, the vibration wave transmitted through solid substance attenuates with distance. Therefore, it is desirable to mount the HDD 40 and microphone 72 separate from each other. To this end, the HDD 40 and microphone 72 are arranged such that the center-of-gravity G1 of the HDD and that G2 of the microphone are positioned at opposite sides with respect to that G3 of the first main unit 62 in the longitudinal direction of the first main unit 62. This structure further reliably prevents noise due to the HDD 40 from being transmitted to the microphone 72, and suppresses the influence of the leakage magnetic flux of the HDD 40 upon the microphone 72.

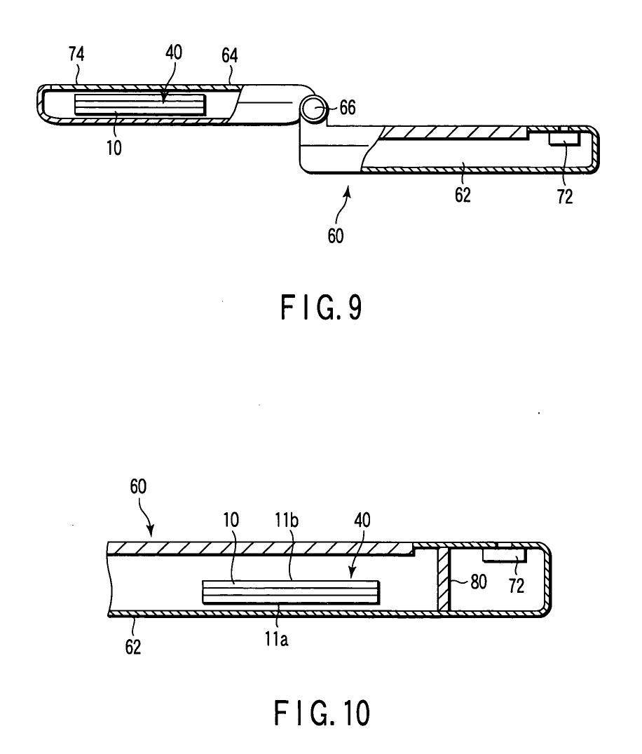

FIG. 9 shows a mobile phone according to a fourth embodiment of the invention. In the fourth embodiment, the HDD 40 is arranged in one of the first and second main units 62 and 64 which constitute the phone main body, e.g., in the second main unit 64, while the microphone 72 is arranged in the other of the first and second main units 62 and 64, e.g., in the first main unit 62. Thus, by containing the HDD 40 and microphone 72 in difference main units, i.e., different cases, the HDD 40 as a vibration source is mounted separately from the microphone 72. As a result, the fourth embodiment can provide the same advantage as the third embodiment.

FIG. 10 shows a mobile phone according to a fifth embodiment of the invention. In the fifth embodiment, the HDD 40 and microphone 72 are arranged in the first main unit 62, and the microphone 72 is located closer to the top cover 11b of the HDD 40 in the thickness direction of the first main unit 62. As in the first embodiment, the HDD 40 and microphone 72 are arranged to satisfy the following relationship:
0≦θ<90°−α max

A plate-like shield member 80 is arranged in the first main unit 62 and positioned between the HDD 40 and microphone 72 to isolate them. The shield member 80 is formed of a magnetic material to magnetically isolate the HDD 40 and microphone 72. The shield member 80 may surround the HDD 40 in the first main unit 62.

This structure prevents noise due to the vibration of the HDD 40 from being transmitted to the microphone 72, thereby enabling clear voice data to be acquired through the microphone. Furthermore, the shield member 80 shields the microphone 72 from the leakage magnetic flux of the HDD 40. This enables clearer voice data to be acquired through the microphone 72.

In the second to fifth embodiments, the other structures are identical with those of the first embodiment. Therefore, like reference numerals are used to designate like portions of the embodiments, and a detailed description of those portions is omitted.

This invention is not limited directly to the embodiments described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

Although in the above embodiments, the electronic device is provided with a plurality of cases, i.e., the first and second main units, it may have a single main unit. The invention is not limited to mobile phones, but is also applicable to various electronic devices, such as video cameras and PDAs. In the embodiments, the HDD is provided with a single magnetic disk. However, it may use a plurality of magnetic disks when necessary. Further, the magnetic disk is not limited to the 0.85-inch one, but may be a 1.8-inch or 2.5-inch one.

What is claimed is:

1. An electronic device comprising:
a device main body;
a disk device arranged in the device main body, the disk device including a rectangular case provided with a bottom and a top cover opposing the bottom, and a disk-shaped recording medium contained in the case; and
a microphone arranged in the device main body closer to the top cover of the disk device than to the bottom of the disk device in a thickness direction of the device main body,
the disk device and microphone being arranged to satisfy the following relationship with respect to a maximum deformation angle α of the top cover of the disk device in a lowest-order vibration mode:
0≦θ<90°−α
where θ represents an angle between a straight line connecting the disk device to the microphone by a most direct way, and a plane parallel to a surface of the top cover of the disk device.

2. The electronic device according to claim 1, wherein a center of gravity of the disk device and a center of gravity of the microphone are positioned at opposite sides with respect to a center of gravity of the device main body in a longitudinal direction of the device main body.

3. The electronic device according to claim 1, wherein:
the device main body includes a first main unit, and a second main unit rotatably coupled to the first main unit by a hinge; and
the disk device is arranged in one of the first main unit and the second main unit, and the microphone is arranged in the other of the first main unit and the second main unit.

4. The electronic device according to claim 1, further comprising a shield member formed of a magnetic material and provided between the disk device and the microphone, the shield member magnetically shielding the microphone from the disk device.

5. The electronic device according to claim 1, wherein the case of the disk device has a length not more than 4 cm.

6. The electronic device according to claim 1, wherein the disk-shaped recording medium has a diameter not more than 1 inch.

7. The electronic device according to claim 1, wherein the disk device includes:
a drive motor which is arranged in the case and supports and rotates the recording medium;
a head which processes information for the recording medium;
a head actuator which is arranged in the case, supports the head for movement, and moves the head with respect to the recording medium;
a substrate unit contained in the case and connected to the head actuator; and
a control circuit board opposing an outer surface of the case and connected to the substrate unit;

8. An electronic device comprising:
a device main body;
a disk device arranged in the device main body, the disk device including a rectangular case provided with a bottom and a top cover opposing the bottom, and a disk-shaped recording medium contained in the case; and
a microphone arranged in the device main body closer to the bottom of the disk device than to the top cover of the disk device in a thickness direction of the device main body,
the disk device and microphone being arranged to satisfy the following relationship with respect to a maximum deformation angle α of the bottom of the disk device in a lowest-order vibration mode:
0≦β<90°−α
where β represents an angle between a straight line connecting the disk device to the microphone by a most direct way, and a plane parallel to a surface of the bottom of the disk device.

9. The electronic device according to claim 8, wherein a center of gravity of the disk device and a center of gravity of the microphone are positioned at opposite sides with respect to a center of gravity of the device main body in a longitudinal direction of the device main body.

10. The electronic device according to claim 8, wherein:
the device main body includes a first main unit, and a second main unit rotatably coupled to the first main unit by a hinge; and
the disk device is arranged in one of the first main unit and the second main unit, and the microphone is arranged in the other of the first main unit and the second main unit.

11. The electronic device according to claim 8, further comprising a shield member formed of a magnetic material and provided between the disk device and the microphone, the shield member magnetically shielding the microphone from the disk device.

12. The electronic device according to claim 8, wherein the case of the disk device has a length not more than 4 cm.

13. The electronic device according to claim 8, wherein the disk-shaped recording medium has a diameter not more than 1 inch.

14. The electronic device according to claim 8, wherein the disk device includes:
a drive motor which is arranged in the case and supports and rotates the recording medium;
a head which processes information for the recording medium;
a head actuator which is arranged in the case, supports the head for movement, and moves the head with respect to the recording medium;
a substrate unit contained in the case and connected to the head actuator; and
a control circuit board opposing an outer surface of the case and connected to the substrate unit.
